(19) United States
(12) Patent Application Publication
(10) Pub. No.: US 2022/0248482 A1
(43) Pub. Date: Aug. 4, 2022

(54) METHOD AND APPARATUS FOR SUPPORTING DEVICE TO DEVICE COMMUNICATION

(71) Applicant: SIERRA WIRELESS, INC., Richmond (CA)

(72) Inventors: Gustav Gerald VOS, Surrey (CA); Steven John BENNETT, Coquitlam (CA)

(21) Appl. No.: 17/589,342

(22) Filed: Jan. 31, 2022

Related U.S. Application Data
(60) Provisional application No. 63/144,345, filed on Feb. 1, 2021.

(51) Int. Cl. H04W 76/14; H04L 5/14; H04L 5/00

(52) U.S. Cl. CPC H04W 76/14; H04L 5/0048; H04L 5/14

(57) ABSTRACT

There is provided a method and apparatus for supporting device to device communication between a source device and a destination device. The method includes transmitting, by the SRC device, one or more of reference signals, data information and control information (CI) in sub-frames (SFs) between two consecutive special SFs in a time division duplex (TDD) pattern. The method further includes receiving, by the SRC device, one or more of other reference signals, other data information and other CI in other SFs between other two consecutive special SFs in the TDD pattern. The method further includes switching, by the SRC device, operations between downlink (DL) and uplink (UL) in the one of the two consecutive special SFs or one of the other two consecutive special SFs. In the method, each frame of the TDD pattern includes at least two special SFs.

### CROSS-REFERENCE TO RELATED APPLICATIONS

This application claims the benefit and priority from U.S. Provisional Patent Application No. 63/144,345 filed Feb. 1, 2021, titled “Method and Apparatus for Supporting Device to Device Communication”, the contents of which are incorporated herein by reference in their entirety.

### FIELD OF THE INVENTION

The present invention pertains to the field of wireless communication and in particular to a method and apparatus for supporting device to device communication in a wireless communication network.

### BACKGROUND

A legacy cellular user equipment (UE) can communicate with another UE through a base station (BS) irrespective of the proximity (e.g. distance) between them. Such communication typically involves the use of licensed resources. On the other hand, device-to-device (D2D) communication, for example sidelink (SL) communication, enables UEs to directly communicate with each other. SL communication can be performed with or without assistance of a BS, which may improve latency and battery life of the UE. Further, the use of the unlicensed bands for SL (SL-U) can provide some benefits without using expensive licensed spectrum thereby reducing the cost of transmission.

However, existing SL protocols have several issues to be overcome in order to improve performance of SL communication. For example, there is a need to determine how a source (SRC) UE acquires a destination (DST) UE's radio network temporary identifier (RNTI) for initial communication with a DST UE. Another issue that needs to be resolved is the maintenance of synchronization between a SRC UE and a DST UE, ideally without reducing the data transmission rate, while the source and destination devices are connected to each other (e.g. SL connected mode). Indeed, there are significant issues to be resolved in order to improve SL communication.

Therefore, there is a need for a method and apparatus for supporting device to device communication between a source device and a destination device, that is not subject to one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

It is an object of the present invention to obviate or mitigate at least one disadvantage of the prior art.

According to an aspect of the present invention, there is provided a method for supporting device to device communication between a source device and a destination device. In accordance with embodiments of the present invention, there is provided a method for supporting device to device (D2D) communication between a source (SRC) device and a destination (DST) device. The method includes transmitting, by the SRC device, one or more of reference signals, data information and control information (CI) in sub-frames (SFs) between two consecutive special SFs in a time division duplex (TDD) pattern. The method further includes receiving, by the SRC device, one or more of other reference signals, other data information and other CI in other SFs between other two consecutive special SFs in the TDD pattern. The method further includes switching, by the SRC device, operations between downlink (DL) and uplink (UL) in the one of the two consecutive special SFs or one of the other two consecutive special SFs. In the method, each frame of the TDD pattern includes at least two special SFs.

In some embodiments, each of the CI and the other CI includes a SRC identifier (ID) and a DST ID and is transmitted via a control channel (CCH). In some embodiments, the SRC device scrambles the CI with the DST ID, and the DST device scrambles the other CI with the SRC ID.

In some embodiments, the method further includes transmitting, by the SRC device, the DST device or both, synchronization information in one or more of the two consecutive special SFs and the other two consecutive special SFs. In some embodiments, the synchronization information includes one or more of synchronization signals and an information block. The information block includes information indicative of system frame timing.

In some embodiments, the method further includes determining, by the SRC device, a DST identifier (ID) for an initial communication with the DST device based on one or more of synchronization signals (SSs), an application ID, a pre-configured group ID and an information block. The information block includes information indicative of system frame timing. In some embodiments, the method further includes transmitting, by the SRC device, a connection request to the DST device, the connection request including the determined DST ID and a SRC ID. If the SRC ID is not known to the SRC device, the method further includes randomly selecting, by the SRC device, a temporary SRC ID.

In some embodiments, in response to the connection request, the method further includes receiving, by the SRC device from the DST device, a connection response. The connection response includes the SRC ID and the DST ID. In some embodiments, the method further includes transitioning, by the SRC device, into a D2D connected mode based on the connection response received from the DST device. The D2D connected mode enables transmission of the data information. In some embodiments, the DST device randomizes one or more of time and frequency of the connection response message and, wherein the SRC device randomizes one or more of time and frequency of the connection request message.

In some embodiments, if the SRC device does not receive a connection response from the DST device within a time period specified by a connection request timeout, the SRC device is prohibited from transmitting a subsequent connection request to the DST device for a predetermined amount of time. In some embodiments, if the SRC device receives a connection response including information indicative of rejection to the connection request, the SRC device refrains from transmitting a subsequent connection request to the DST device for a requested back-off time included in the connection response or a predetermined amount of time. In some embodiments, the predetermined amount of time increases exponentially each time that the connection request is rejected.

In some embodiments, the method further includes configuring, by the SRC device, the reference signals based on the DST ID, and configuring, by the DST device, the other reference signals based on the SRC ID. In some embodiments, the reference signals include one or more of a demodulation reference signal (DMRS) and cell-specific reference signal (CRS).

In accordance with embodiments of the present invention, there is provided a source (SRC) device for supporting device to device communication between a source device and a destination device. The SRC device includes a processor and machine readable memory storing machine executable instructions. The machine executable instructions, when executed by the processor configure the SRC device to perform the one or more of above defined methods.

Embodiments have been described above in conjunction with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates an example of the time division duplex (TDD) pattern for data transmission when a source device and a destination device are in a sidelink (SL) connected mode, in accordance with embodiments.

FIGS. 2A, 2B and 2C illustrate examples of a special subframe format used for transmission switching in TDD, in accordance with embodiments.

FIG. 3 illustrates an example of SL connection mode transitions at a source device and a destination device, in accordance with embodiments.

FIG. 4 illustrates methods of scrambling in SL communication, in accordance with embodiments.

FIG. 5 illustrates a method for supporting device to device communication between a source (SRC) device and a destination (DST) device, in accordance with embodiments.

FIG. 6 is a schematic diagram of an electronic device according to embodiments.

It will be noted that throughout the appended drawings, like features are identified by like reference numerals.

### DETAILED DESCRIPTION

It will be readily understood that communication between wireless devices can be enabled in multiple ways, and it can be defined as device to device (D2D) communications, for example sidelink (SL) communications. However, it will be readily understood by a worker skilled in the art how to apply any embodiments which may be defined herein as SL communications to a more general version of D2D communications.

In the present disclosure, the term “transmit device” or “transmitting device” is used to define a device, for example a user equipment (UE), which transmits sync, control or data channels. In addition, the term “receive device” or “receiving device” is used to define a device, for example a UE, which receives sync, control or data channels.

In the present disclosure, the term source (SRC) device is used to define a device, such as a UE, which initiates D2D communication or a D2D connection with a destination (DST) device. In addition, the term DST device is used to define a device, such as a UE or a gateway, which receives a request for D2D communication or a D2D connection from a SRC device. It will be readily understood by a person skilled in the art that both the SRC device and the DST device are configured to perform transmission, reception or both transmission and reception of information that can enable D2D communication or a D2D connection. In other words, each of the SRC device and the DST device can be one or both of a transmit or transmitting device and a receive or receiving device.

In the present disclosure, the term device and the term UE are interchangeably used. Moreover, the term “SCI connection request” and the term “SL connection request” can be used interchangeably, and the term “SCI connection response” and the term “SL connection response” can be used interchangeably.

The present disclosure provides methods and apparatuses for supporting device to device (D2D) communication, for example sidelink (SL) communication, between a source device and a destination device (e.g. between two wireless devices). As stated above, existing SL protocols have several issues to be overcome in order to improve performance of D2D communication or SL communication, which will be further discussed below along with solutions provided by embodiments of the present disclosure.

### Determination of DST ID for Initial Access:

In D2D communication, in order to establish a connection between a SRC device and a DST device, the SRC device needs to know a DST identifier (ID) (e.g. DST radio network temporary identifier (RNTI)) in light of the fact that based on currently existing D2D communication protocols (e.g. SL protocols) as implemented in long term evolution machine type communication (LTE-MTC), the control information (CI) is scrambled based on the DST ID. For example, the sidelink control information cyclic redundancy check (SCI CRC) may be scrambled based on the DST RNTI. As such, a means by which a SRC device acquires the DST ID for its initial communication with a DST device (e.g. initial access to the DST device) is required.

According to embodiments, if the DST device, such as a gateway, broadcasts synchronization signals (SS), the SRC device can acquire the DST ID based on one or more of the SS, an information block (e.g. master information block (MIB) or other information block containing at least system frame timing), an application ID and a pre-configured group ID. The information block may include information indicative of system frame timing. It may be noted that SS is configured for synchronization in time and frequency and that SS includes both primary synchronization signals (PSS) and secondary synchronization signals (SSS). It may be also noted that the information block (IB) is configured to provide additional information needed for configuration of the synchronizing UE.

In some embodiments where the DST device broadcasts SS, the SRC device can determine the DST ID. For example, where the DST ID is DST RNTI, the DST RNTI can be defined as shown in Equation 1 below:

DST RNTI=PSS_ID+SSS_ID*3+Frac_RNTI_ID*504 (1)

Having regard to Equation 1 above, ‘PSS_ID’ represents an identifier of PSSS (primary sidelink synchronization signal) and ‘SSS_ID’ represents an identifier of SSSS (secondary sidelink synchronization signal). ‘Frac_RNTI_ID’ is an 8-bit field that is defined in the master information block (MIB)/physical broadcast channel (PBCH). The Frac_RNTI_ID may occupy some of the currently unused bits in the MIB, for example the 10 spare bits which are present, may be used in LTE-M. The size of DST RNTI can be variable depending on the size of the Frac_RNTI_ID. For example, if the size of the Frac_RNTI_ID is 8 bits, the DST RNTI determined by the above Equation 1 may be a 16 bit DST RNTI. It is understood that the size of the Frac_RNTI_ID may be greater than or less than 8 bits, and can be expanded or contracted.

According to embodiments, if the DST device does not broadcast synchronization signals (SS), a DST ID (e.g. DST RNTI) can be determined in a different manner than the above. Moreover, the manner by which the DST ID (e.g. DST RNTI) is determined can vary depending on whether the SRC device has access to a SL server (for example a SL server which may be configured as a central server). Specifically, for SRC devices with access to a server, the SRC device can determine the DST ID (e.g. RNTI of a DST device) wherein the DST device is within the range of the server (for example, the DST device is within the coverage area for which the SL server can provide service). The SL server can manage the mapping of an application identifier (ID) to the DST ID (e.g. associating an application ID with the DST RNTI) and subsequently determine which DST device(s) may be sufficiently close to the SRC device in order to communicate with the SRC device.

According to embodiments, for SRC devices without access to a SL server, the DST ID (e.g. DST RNTI) may be selected from a pre-configured group of IDs (e.g. RNTIs) to which all DST devices would listen and respond. If the SRC device (e.g. SRC UE) is not synchronized with a DST device (e.g. DST UE), the SRC device can blindly and repeatedly transmit a SL-synchronization (SYNC) signal followed by a SL timing request message, until the SL-SYNC signal is received by a DST device within the DST device's Rx Sync window. The DST device can receive the SL-SYNC signal and SL timing request message, and in response the DST device can transmit a timing response message. The timing response message, for example, can include one or more of the following pieces of information:
Precise timing information: μsec timing correction to the nearest subframe (SF) and SF timing
Macro timing information: System frame timing, similar to Master Information Block (MIB), and hyper frame timing, similar to System Information Block (SIB)
Sync method information: For example, global navigation satellite system (GNSS), PSS/SSS/MIB, transmitter (Tx) beacon, etc.
UE ID: ID of the DST device (e.g. DST UE) that may be used to calculate future SL-POs
SL-discontinuous reception (SL-DRX) information: SL-DRX may be used to calculate future SL-POs
Receiver (Rx) beacon information: Rx beacon ID and SL-DRX

In some embodiments, the unsynchronized SRC device (e.g. SRC UE) does not transmit the SL timing request message but transmits a special sync signal as the SL timing request message. The special sync signal may be configured as a combination of the SL-SYNC and the SL timing request message. Upon detecting the special sync signal during the Rx sync window, the DST device (e.g. DST UE) can broadcasts the timing response message.

In some embodiments, the timing request method illustrated above may be enhanced using optional receiver (Rx) beacons that are configured to listen for the SL-SYNC signals more frequently.

### Send SS During D2D Connected Mode:

In D2D communication (e.g. SL communication), synchronization between a SRC device and a DST device needs to be maintained while the SRC device and DST device are connected (e.g. during SL connected mode). In order to maintain the synchronization, it can be desired to transmit one or more synchronization signals (e.g. SS or sidelink SS (SLSS)), ideally without a decrease of the data transmission rate.

According to embodiments, a SRC device and a DST device enter into a time division duplex (TDD) pattern with a period of 10 ms (e.g. 1 frame), the SRC device and the DST device can alternatively transmit reference signals, data information, control information (CI) or any combination thereof, during the 4 ms between these two special subframes (SFs). Put another way, the D2D connected mode can allow the SRC device and the DST device to transmit one or more of reference signals, data information and control information (CI). It should be noted that the alternate transmission of the SRC device and DST device can entail the SRC device and the DST device not transmitting (e.g. in a transmission mode) at the same time. Put another way, the SRC device and the DST device cannot be transmitting devices at the same time. In some embodiments, the special SFs are present every 5 ms (i.e. periodically with the same time interval). In some embodiments, each special SF is present non-regularly and may be randomly presented (i.e. not always present after a certain time interval (e.g. special SF is present every 5 ms)). In other words, each special SF may be present after unequal amounts of time (e.g. the special SF is present 4 ms after the previous one, and then is followed by the next special SF after 6 ms). The special SFs may be considered to be marker SFs. For example, the special SFs can be configured the same as or similar to special SFs defined within respect to LTE TDD that are used for indicating switching between downlink (DL) and uplink (UL). The special SFs may also be used to transmit synchronization information, such as synchronization signals (e.g. PSS, SSS) and an information block (e.g. information indicative of system frame timing). Other configurations of these special SFs would be readily understood by a worker skilled in the art.

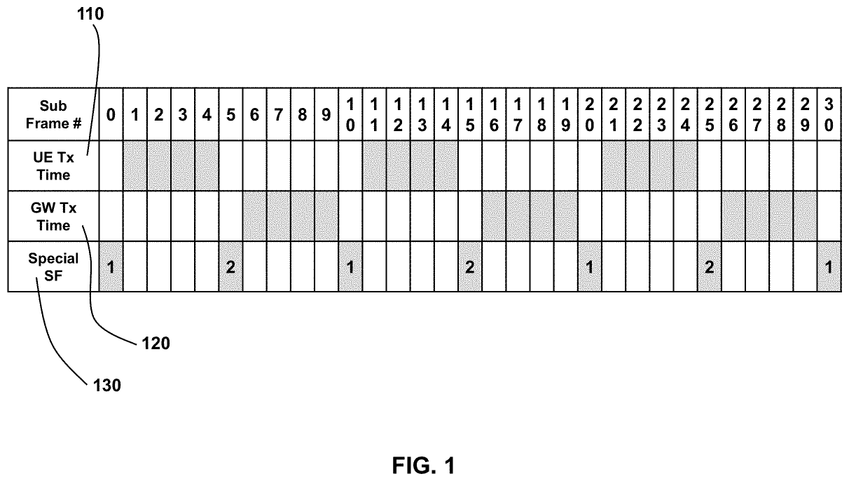

FIG. 1 illustrates an example of the TDD pattern for data transmission when a SRC device and a DST device are in a SL connected mode, in accordance with embodiments of the present disclosure. It is noted that in FIG. 1, “UE TX time” represents the time that the UE transmits data, “GW TX Time” represents the time that the gateway transmits data.

Referring to FIG. 1, the UE TX time 110 occupies subframe (SF) numbers 1 to 4, 11 to 14 and 21 to 24. In other words, these SFs are designated for uplink (UL) data transmission performed by the UE. Similarly, the GW TX time 120 occupies subframe (SF) numbers 6 to 9, 16 to 19 and 26 to 29. In other words, these SFs are designated for downlink (DL) data transmission performed by the gateway. The special SFs 130 are present at SF numbers 0, 5, 10, 15, 20, 25 and 30. These SFs are designated for switching modes, namely from DL to UL or vice versa. While FIG. 1 illustrates that special SFs 130 are present at every 5 ms (i.e. periodically with the same time interval, at SF numbers 0, 5, 10, 15, 20, 25 and 30), in some embodiments, special SFs 130 can be present non-regularly or randomly (i.e. not always present every 5 ms). In other words, each special SF 130 may be present after unequal amounts of time (e.g. the special SF is present 4 ms after the previous one, and then is followed by the next special SF after 6 ms).

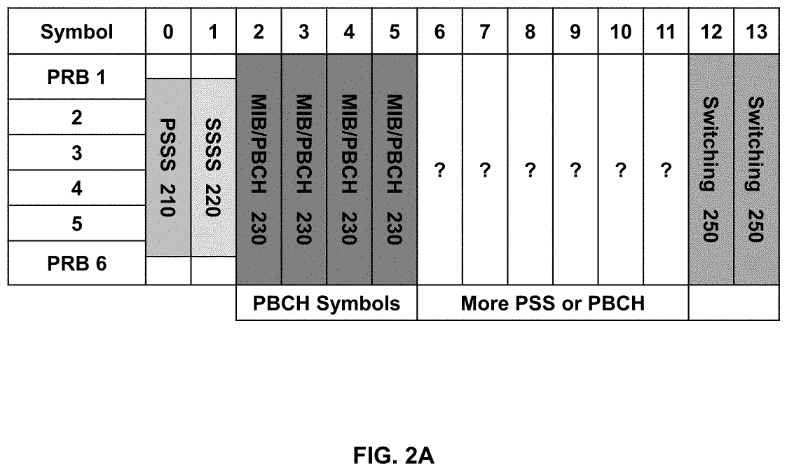

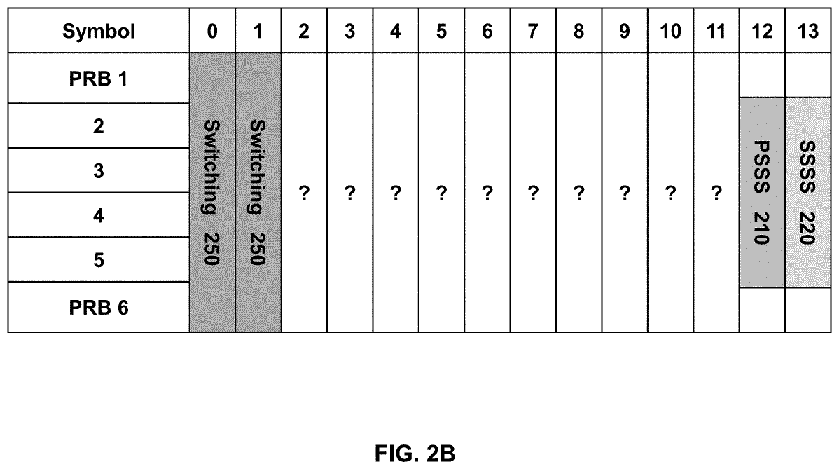

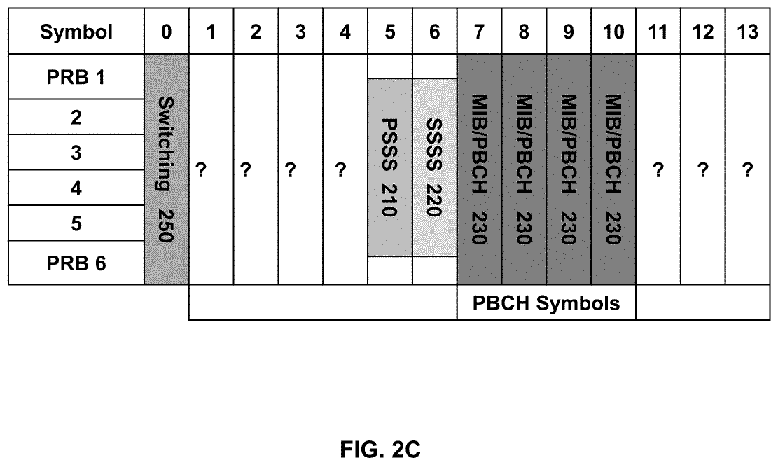

According to embodiments, the special SFs 130 are used to transmit synchronization signals (SSs) as many devices (e.g. UE) can perform the transmission switching operation faster than the time allocated to the special SF (i.e. 1 SF, 1 ms). In various embodiments, only two symbols are needed for the switching operation. Three example formats for a special SF are illustrated in FIG. 2A, FIG. 2B and FIG. 2C.

In some embodiments, the formats of the special subframes used can depend on which device is acting at a SRC device and which is acting as a DST device.

FIG. 2A illustrates an example of a special SF format used for transmission switching in TDD where PSSS/SSSS/MIB(PBCH) SF structure is used when mod (subframe number, 10)=0, in accordance with embodiments of the present disclosure. Referring to FIG. 2A, PSSS 210 occupies symbol 0, SSSS 220 occupies symbol 1, and a number of MIB/PBCH 230 occupy symbols 2 to 5. In FIG. 2A, symbols 2 to 5 may be referred to as PBCH symbols. The switching operation 250 can take place at symbols 12 and 13 thereby allowing the device (e.g. UE) to perform the transmission switching operation during the special SF. Symbols 6 to 11 that are marked by ‘?’ mark in FIG. 2A may be designated for re-transmission of PSSS, SSSS or PBCH in order to improve sync coverage, according to some embodiments of the present disclosure.

FIG. 2B illustrates an example of a special SF format used for transmission switching in TDD where PSSS/SSSS SF structure is used when mod (subframe number+5, 10)=0, in accordance with embodiments of the present disclosure. Referring to FIG. 2B, the switching operation 250 can take place at symbols 0 and 1 thereby allowing the device (e.g. UE) to perform the transmission switching operation 250 during the special SF. PSSS 210 occupies symbol 12 and SSSS 220 occupies symbol 13. Symbols 2 to 11 that are marked by ‘?’ mark in FIG. 2B may be designated for re-transmission of PSSS or SSSS in order to improve sync coverage, according to some embodiments of the present disclosure.

FIG. 2C illustrates an example of a special SF format used for transmission switching in TDD where PSSS/SSSS/MIB(PBCH) SF structure is used in accordance with embodiments of the present disclosure. Referring to FIG. 2C, PSSS 210 occupies symbol 5, SSSS 220 occupies symbol 6, and a number of MIB/PBCH 230 occupy symbols 7 to 10. In FIG. 2C, symbols 7 to 10 may be referred to as PBCH symbols. The switching operation 250 can take place at symbol 0 thereby allowing the device (e.g. UE) to perform the transmission switching operation during the special SF. Symbols 1 to 4 and 11 to 13 that are marked by ‘?’ mark in FIG. 2C may be designated for re-transmission of PSSS, SSSS or PBCH in order to improve sync coverage, according to some embodiments of the present disclosure.

According to embodiments, using the special SF formats illustrated in FIGS. 2A, 2B and 2C, PSSS 210 and SSSS 220 can be transmitted every 5 ms and PBCH (MIB) 230 can be transmitted every 10 ms. The transmission intervals for PSSS 210, SSSS 220 and PBCH(MIB) 230 can be equally implemented in legacy LTE and the overall structure of the special SF can be substantially equivalent to or similar to that used in legacy LTE, which can reduce development time.

### DST Device Sends CI Back to the SRC Device:

In D2D communication (e.g. SL communication), a DST device transmits control information (e.g. sidelink control information (SCI)) back to the SRC device, for example in the acknowledgment (ACK) message. The CI may be transmitted via a control channel (CCH). The CI transmitted by the DST device may include both SRC ID (e.g. SRC RNTI) and DST ID (e.g. DST RNTI). The SRC device needs to verify whether the received CI is intended for it or for another device (e.g. determining if the CI was intended for the SRC device or for another device). Such verification is needed in order to avoid collisions with respect to CI transmissions. Otherwise, further steps need to be processed or performed at a higher layer in order to provide CI collision prevention.

According to embodiments, when the CI (e.g. SCI message) is transmitted from the SRC device to the DST device, the SRC device scrambles the control information (CI) with DST ID. For example, when the SRC device is a transmitting device, the SRC device may scramble the CI (e.g. control information cyclic redundancy check or sidelink CI CRC) with the DST ID (e.g. DST RNTI). The CI may be transmitted via a control channel (CCH). The CI transmitted by the SRC device may include both SRC ID (e.g. SRC RNTI) and DST ID (e.g. DST RNTI). In some embodiments, CI (e.g. SCI CRC) is scrambled by the SRC device using the DST ID (e.g. DST RNTI) based on currently existing D2D protocols (e.g. SL protocols) implemented in LTE-MTC.

According to embodiments, similar to the above, when the CI is transmitted from the DST device to the SRC device, the DST device scrambles CI with SRC ID. For example, when the DST device is a transmitting device, the DST device may scramble the CI (e.g. control information cell-specific reference signal or sidelink CI CRS) with the SRC ID (e.g. SRC RNTI). In some embodiments, CI (e.g. SCI CRS) is scrambled by the DST device using the SRC ID (e.g. SRC RNTI) based on currently existing SL protocols implemented in LTE-MTC.

In some embodiments, the DST device can acquire the SRC ID (e.g. SRC RNTI) from one or more CI messages. For example, the SRC RNTI may be included, as a field, in every CI message transmitted from the SRC device to the DST device. However, this method can increase the size of the CI messages which may result in an increase in signaling overhead.

In some embodiments, the DST device can acquire the SRC ID (e.g. SRC RNTI) only from the connection request (e.g. SL connection request). This method can reduce the size of the CI messages, in particular when compared to the above disclosed method. In some embodiments where the DST device acquires the SRC ID (e.g. SRC RNTI) from the connection request, the DST device can optionally further scramble the CI CRC with the SRC ID (e.g. SRC RNTI). However, this scrambling typically may not be applied to the connection request. It should be noted that the connection request is only scrambled with the DST ID (e.g. DST RNTI).

It should be further noted that, in various embodiments where the DST device can acquire the SRC ID (e.g. SRC RNTI) from the CI message(s) or the connection request, CI collisions may occur when there is another SL transaction or transmission within the same coverage area using the same SRC ID and the same DST ID. It will be understood that it can be highly unlikely in the cases where 16-bit SRC RNTIs and 16-bit DST RNTIs are used. Methods of scrambling CI can be presented below or elsewhere in this application.

Initial Access of SRC Device with DST Device

For effective D2D communication (e.g. SL communication), an initial communication between a SRC device and the DST device (e.g. initial access with the DST UE by the SRC UE) needs to be quickly processed while avoiding or minimizing collisions (e.g. SCI collision) and congestion (e.g. network congestion). For example, collision and/or congestion may cause one or more of queueing delay, packet loss and blocking of new connections. Further, it is to be determined as to how a SRC device transmits a connection request to the DST device when a SRC ID (e.g. SRC RNTI) has not been assigned or is not known to the SRC device.

According to embodiments, the SRC device can send a connection request to the DST device in order to establish the connection between the SRC device and the DST device. For example, when the SRC device and the DST device are transitioning into the D2D connected mode (e.g. SL connected mode). In order to send the connection request (e.g. SCI connection request), the SRC device determines the DST ID (e.g. DST RNTI) and SL-POs, as would be readily understood by a person of ordinary skill in the art to which this invention belongs. The connection request may include the SRC ID (e.g. SRC RNTI), if the SRC ID is known. If the SRC ID is not known to the SRC device, the connection request (e.g. SCI connection request) may include a temporary SRC ID (e.g. temporary SRC RNTI) which can be randomly chosen from a set of SRC ID candidates (e.g. FF00 to FFFF). In some embodiments, the SCI connection request further includes a field indicative of whether the SRC ID (e.g. SRC RNTI) included in the request is a legitimate SRC ID (i.e. a legitimate SRC RNTI known to the SRC device) or a temporary SRC ID (e.g. temporary SRC RNTI). In some embodiments, the SRC device can select a DST SL-PO randomly, if there is more than one available DST SL-PO. In some embodiments, the SRC device may select which resources are used, for example the SRC device may select which 3 physical resource blocks (PRBs) are required to be used for transmitting the connection request (e.g. SCI connection request).

According to embodiments, the SRC device can receive a response to the connection request (e.g. SCI connection request). The received connection response (e.g. SCI connection response) can indicate whether the connection request is accepted or rejected. If the SRC device receives a connection response with indications that the connection request is rejected and a back-off request time is greater than zero, the SRC device can back off for the requested back-off time (e.g. the amount of time indicated by the back-off request time). In other words, the SRC device refrains from transmitting another connection request to the DST device for the requested back-off time. However, if the SRC device receives a connection response with indications that the connection request is rejected and a back-off request time is zero, the SRC device would back off for a predetermined amount of time or may retry immediately and back off for a predetermined amount of time after a predetermined number of retry attempts. Put another, the SRC device refrains from transmitting another connection request to the DST device for the predetermined amount of time immediately after the failure (e.g. connection request is rejected) or after a predetermined number of failures. Furthermore, once the SRC device sends a connection request, the SRC device expects a connection response from the DST device within a certain time period. As such, if the SRC device does not receive a connection response within a connection request timeout (e.g. CONNECTION_REQ_TO=20 ms), the SRC device can back off for a predetermined amount of time. Put another way, if the SRC device does not receive a connection response from the DST device within the expiry of the connection request timeout, the SRC device would refrain from transmitting a subsequent connection request to the DST device for a predetermined amount of time. In some embodiments, the SRC device optionally uses exponential back-off for each failed attempt. If the SRC device receives a connection response with an indication that the connection request is accepted, then the SRC device can transition into the D2D connected mode (e.g. SL connected mode). The DST device would also transition into the D2D connected mode once it sends the connection response with an indication that the connection request is accepted.

According to embodiments, the SRC device and the DST device can exit from the D2D connected mode (e.g. SL connected mode) and/or return to the idle mode (e.g. SL idle mode). In some embodiments, the SRC device and the DST device exit from the D2D connected mode and/or return to the idle mode, when both the SRC device and the DST device send a release request. In some embodiments, the SRC device and the DST device exit from the D2D connected mode and/or return to the idle mode, after a certain time period of inactivity, which may be associated with an inactivity timer, for example. The inactivity time period that triggers the transition into the idle mode may be predetermined. In some embodiments, the SRC device and the DST device exit from the D2D connected mode upon receiving/sending the connection response (e.g. SL connection response) with an indication that the connection request is rejected.

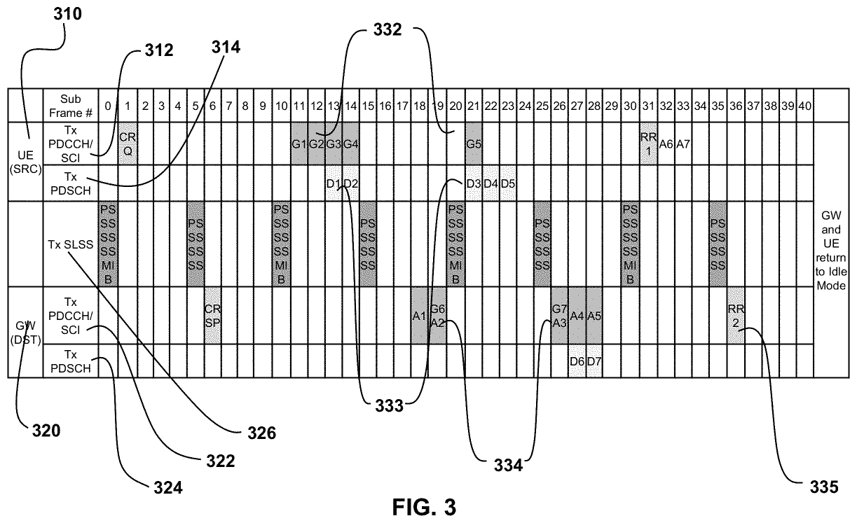

FIG. 3 illustrates an example of SL connection mode transitions at a SRC device and a DST device, in accordance with embodiments of the present disclosure. In this example, the SRC device 310 and the DST device 320 transition into a SL connected mode. The SRC device 310 sends 5 transport blocks (TBs) to the DST device 320 and the DST device 320 sends 2 TBs to the SRC device 310. The SRC device 310 and the DST device 320 subsequently exit from the SL connected mode. It should be noted that in some embodiments, the SRC device 310 may be a UE and the DST device 320 may be a gateway. In other embodiments, both the SRC device and the DST device are UEs.

Referring to FIG. 3, at SF numbers 0, 10, 20 and 30 (e.g. mod (SF number, 10)=0), the DST device 320 and/or SRC device 310 transmits a sidelink synchronization signal (SLSS) which contains PSSS, SSSS and MIB, through the Tx SLSS channel 326. At SF numbers 5, 15, 25 and 35 (e.g. mod (SF number+5, 10)=0), the DST device 320 transmits a SLSS, which contains only PSSS and SSSS, through the Tx SLSS channel 326.

With further reference to FIG. 3, at SF number 1, the SRC device 310 sends a SCI connection request control information to the DST device 320 through the Tx physical downlink control channel (PDCCH)/SCI 312. The SCI connection request may be sent on the SL-PO for the DST device 320 (e.g. GW SL-PO). In response, at SF number 6, the DST device 320 transmits the SCI connection response control indication to the SRC device 310. According to embodiments, when the DST device 320 transmits the SCI connection response, the SRC device 310 and the DST device 320 may transition into the SL connected mode.

With respect to data transmission from the SRC device 310 to the DST device 320, the SRC device 310 transmits grants (i.e. G1 to G5 332) to the DST device 320 through the Tx PDCCH/SCI 312 at SF numbers 11 to 14 and 21, respectively. The grant transmitted to the DST device 320 may include a grant for the MCS (modulation and coding scheme) and resources. Upon transmitting each grant, the SRC device 310 transmits data (i.e. D1 to D5 333) to the DST device 320 through the Tx physical downlink shared channel (PDSCH) 314 at SF numbers 13 to 14 and 21 to 23, respectively. Upon receipt of each data block, the DST device 320 transmits acknowledgement (ACK) messages (i.e. A1 to A5 334) to the SRC device 310 through the Tx PDCCH/SCI 322 at SF numbers 18 to 19 and 26 to 28, respectively. Upon receipt of the ACK from the DST device 320, the SRC device 310 transmits a release request 335, at SF number 31.

Similarly, with respect to data transmission from the DST device 320 to the SRC device 310, the DST device 320 transmits grants (i.e. G6 and G7) to the SRC device 310 through the Tx PDCCH/SCI 322 at SF numbers 19 and 26, respectively. Upon transmitting each grant, the DST device 320 transmits data (i.e. D6 and D7) to the SRC device 310 through the Tx PDSCH 324 at SF numbers 27 and 28, respectively. Upon receipt of each data block, the SRC device 310 transmits ACK messages (i.e. A6 and A7) to the DST device 320 through the Tx PDCCH/SCI 312 at SF numbers 32 and 33, respectively. Upon receipt of the ACK from the SRC device 310, the DST device 320 transmits a release request, at SF number 36.

When all processes are completed, including transmission of release requests from each of the SRC device 310 and the DST device 320, both of the SRC device 310 and the DST device 320 can exit from the SL-connected mode and return to the SL-idle mode.

In legacy methods, timing is adjusted using a timing advance parameter which is received in the RRC message. In some embodiments, the SRC device uses a fixed timing advance to adjust its timing when the SRC device performs its initial communication with the DST device without the RACH procedure and without receiving the timing advance. Using a fixed timing advance allows the SRC device to ensure that the messages are correctly received and decoded. Further using an appropriate timing advance value will also allow for a bigger separation distance between the SRC device and the DST device. In some embodiments, the timing advance is a value proportionate to or a multiple of the value of the cyclic prefix used. In some embodiments, the SRC device may be configured to select the best timing advance value which allows one or more of the maximum separation distance between the SRC device and the DST device, best performance, best timing and the like.

### Multiple DST Devices or Gateways

When there are several DST devices or gateways deployed within the same coverage area, the determination of how a SRC device selects a DST device for connection while avoiding denial of service (DoS) is desired.

According to embodiments, provided that a plurality of DST devices or gateways (e.g. from different manufacturers) are deployed within the same coverage and these devices or gateways have different RNTIs, the SRC device can select a DST device (or gateway) with the strongest signal detected by the SRC device. For example, when considering devices of equal capability, the DST device that is closest to the SRC device is likely to have the strongest signal that is detected by the SRC device. Upon selection of the DST device with strongest signal, the SRC device can execute D2D connection (e.g. SL connection) procedures and attempt authentication with the selected DST device. If the authentication process fails, the SRC device can mark that selected DST device (or gateway) as forbidden. Subsequently, the SRC device can select another DST device (or gateway) with the next strongest coverage and execute D2D connection (e.g. SL connection) procedures in order to attempt authentication with the re-selected DST device (or gateway).

In various embodiments, the list of forbidden devices (e.g. DST devices or gateways that are marked as forbidden) can be cleared after a certain period of time (e.g. FORBIDEN_LIST_TIMEOUT=8 hours). In some embodiments, in order to prevent or mitigate malicious third party access, the registration procedure defined above between the SRC device and a currently forbidden DST device may be recommenced only after the timeout period for the forbidden device list has expired.

Multiple DST Devices with Same ID

When several DST devices or gateways (e.g. DST devices and gateways from different manufacturers) are deployed within the same coverage area and at least two of them have the same RNTI, conflict can arise with respect to the connection response message. Specifically, all DST devices having the same RNTI will respond to the same connection response (CRSP) message. Therefore, a mechanism to resolve this conflict is needed.

According to embodiments, when several DST devices or gateways are deployed within the same coverage area and at least two of them have the same RNTI, the SRC device can be configured to de-prioritize the DST devices having the same RNTI. In some embodiments, the SRC device may consider that more than one DST devices have (or share) the same RNTI when a plurality of CRSP messages (i.e. more than one CRSP message) are decoded. In some embodiments where RNTIs are broadcasted (e.g. when RNTIs are broadcasted by DST gateways), the SRC device is configured to determine whether the same DST ID (e.g. DST RNTI) is shared by two or more gateways.

According to embodiments, upon detection of a duplicate DST ID (for example, a DST RNTI is shared by two or more devices), the SRC device can inform higher network layers and request re-assignment of DST IDs in order that each DST device or gateway within the coverage area is assigned a different DST ID (e.g. different DST RNTI). The DST device can randomize one or more of time and frequency of the connection response (CRSP) message and the SRC device can randomize one or more of time and frequency of the connection request message. If the SRC device decodes two or more CRSP messages, the SRC device and determine which DST device to respond to either in a random manner or based on a predetermined protocol.

According to embodiments, the connection response message can include a large (e.g. 20-bit) random number (e.g. a SL connection ID). The large random number or the connection ID can be used to scramble at least part of the CI while the DST device is in the D2D connection mode (e.g. SL connection mode). As a large number of bits are used for the random number, it can be considered to be highly unlikely that the same random number is chosen by two or more DST devices. Moreover, even if two or more DST devices select the same random number, application data would not be decodable due to encryption applied to the application data, and therefore the connection will likely be dropped upon failure to decode the application data by the DST device.

### Data Channel

In the 3rd Generation Partnership Project (3GPP) LTE SL protocol, the SL data channel is established based on the uplink (UL) data channel, which is specified as a physical uplink shared channel (PUSCH). The PUSCH uses discrete Fourier transform spread orthogonal frequency division multiple access (DFT-S-OFDMA). Provided that LTE devices already know how to encode the PUSCH, minimal modification of the process is required based on a new encoder or a new encoding process for the data channel. On the other hand, LTE devices do not decode PUSCH (i.e. DFT-S-OFDMA) due to PUSCH's distinctive pilot symbol patterns (i.e. PUSCH has very different pilot symbol patterns). A newly created decoder or existing decoder with major modification would be required for the LTE device to decode 3GPP LTE SL signal based on PUSCH.

In some embodiments, in order to reduce commercialization costs and effort for implementing a new data channel decoder, the SL protocol data channel used in various embodiments can be based on the 3GPP LTE physical downlink shared channel (PDSCH). As LTE devices already know how to decode the PDSCH, minimal modification is needed for a new decoder or a new decoding process for the data channel.

In the case of the encoder, commercialization costs and efforts for implementing a new data channel encoder may be less necessary than the case of the new data channel decoder.

According to embodiments, the modulation of the PDSCH can be limited to quadrature phase shift keying (QPSK) and 16 quadrature amplitude modulation (QAM) thereby reducing peak-to-average power ratio (PAPR). The control format indicator (CFI) may be also pre-configured to “0”. In other words, only 13 out of 14 symbols per SF are used. In some embodiments, a non-standard format may be created in order to use all 14 symbols per SF.

According to embodiments, the “physical layer cell identity” (i.e. N_{cell}^{ID}) can be generated based on a truncation of the DST UE RNTI (e.g. N_{cell}^{ID}=mod (DST device's RNTI,504)) for SL communication or SL data transmission. As such, there is no need to bias the cell-specific reference signal resource element (CRS RE) pattern(s) and sequence(s) on the physical layer cell identity, N_{cell}^{ID}. In some embodiments, for further simplification, only the normal CP can be used or the CP length can be pre-configured.

### Control Channel (CCH)

As stated above, the 3GPP LTE SL protocol establishes the SL control channel based on the UL data channel, which is specified as the physical uplink shared channel (PUSCH). It is understood that the PUSCH uses DFT-S-OFMDA. As LTE devices already know how to encode PUSCH, there would be reduced modifications required for an existing encoder or encoding process for the control channel (e.g. PUCCH). On the other hand, LTE devices do not decode PUSCH (i.e. DFT-S-OFDMA) due to PUSCH's distinctive pilot symbol patterns (for example, the PUSCH has very different pilot symbol patterns). As such a newly created decoder or existing decoder with major modification would be required for the LTE device to decode 3GPP LTE SL signal based on PUSCH.

According to embodiments, in order to reduce commercialization costs and effort for implementing a new control channel decoder, the SL protocol data channel that can be used in various embodiments can be based on the 3GPP LTE machine type communication physical downlink shared channel (MPDSCH). As LTE-M devices already know how to decode MPDSCH, small modification is needed for a new decoder or a new decoding process for the control channel. In the case of the encoder, commercialization costs and efforts for implementing a new control channel encoder would be less than the case of the new control channel decoder.

According to embodiments, the control format indicator (CFI) may also be pre-configured to “0”. In other words, only 13 out of 14 symbols per SF may be used. In some embodiments, a non-standard format may be created to use all 14 symbols per SF. For pilot symbols, either of demodulation reference signal (DMRS) or cell-specific reference signal (CRS) can be used by the decoder. In some embodiments where the CRS is used, the “physical layer cell identity” (i.e. N_{cell}^{ID}) can be generated based on a truncation of the DST UE RNTI (e.g. N_{cell}^{ID}=mod (DST device's RNTI,504)) for SL communication or SL data transmission. As such, there is no need for the CRS RE pattern(s) and sequence(s) to be based on the physical layer cell identity, N_{cell}^{ID}. In some embodiments, for further simplification, only the normal CP is used. In some embodiments where DMRS is used, the RE pattern and sequence can be based on coverage enhancement mode A (CE Mode A) settings (e.g. N_{acc}=1). The values for n^{MPDCCH}_{SCID} may be fixed, for example n^{MPDCCH}_{SCID}=2, and the values for n^{MPDCCH}_{ID,i} can be pre-configured or set based on the DST device's RNTI.

In some embodiments, the SRC device configures reference signals, such as demodulation reference signal (DMRS or DRS), based on DST ID (e.g. DST RNTI) and the DST device configures reference signals, such as DMRS or DRS, based on SRC ID (e.g. SRC RNTI).

### Control Information (CI)

In various embodiments, methods and features illustrated in this application may require certain information to be included in the control information (CI), such as SL control information (SCI). The following are example fields that can be included in the SCI:

Common fields (included in all SCI messages):
SCI type field
RNTI of transmit device (Optional)
cyclic redundancy check (CRC)

SL connection request message (when SCI Type=0):
transmit device RNTI (Optional)

SL connection response message (when SCI Type=1):
accept or reject
back-off time
SL connection ID (Optional)

SL data grant (and ACK/NACK and CQI) message (when SCI Type=3):
resource (e.g. PRBs, repeats)
modulation and coding scheme (MCS)
new data indication (NDI)
channel quality indicator (CQI)—for adaptive modulation and power control
ACK/NACK HARQ ID(s)

Release request message (when SCI Type=4):
release request status—Yes or No

### CI Scrambling

According to embodiments, one or more of the CI and the CI CRC may be scrambled with one or more of the transmit device's ID (e.g. RNTI), the receive device's ID (e.g. RNTI) and the connection ID (e.g. SL connection ID). In some embodiments, one or more of the CI and the CI CRC are not scrambled at all. In some embodiments, the connection request (e.g. SCI connection request) is scrambled only with the receive device's ID (e.g. DST RNTI). In some embodiments, the connection response (e.g. SCI connection response) is scrambled only with one or more of the receive device's ID (e.g. SRC RNTI) and the transmit device's ID (e.g. DST RNTI).

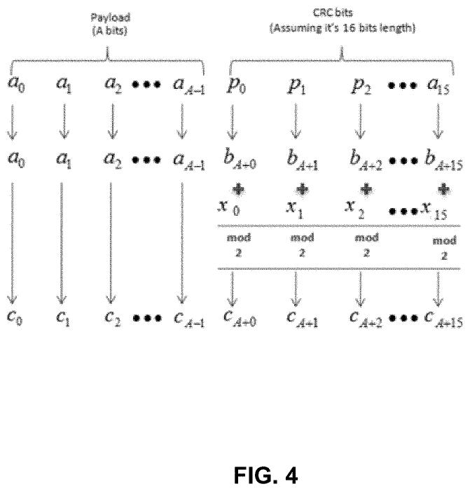

According to embodiments, there are at least two possible methods of scrambling in D2D communication (e.g. SL communication) as further illustrated in FIG. 4. A first method of scrambling is similar to the scrambling method used in LTE in that only SCI CRC is scrambled based on Xᵢ., for example X₁, X₂, X₃ . . . X₁₅, as shown in FIG. 4.

However, unlike the scrambling method used in LTE which determines Xᵢ based solely on cell radio network temporary identifier (C-RNTI), Xᵢ is determined based on one or more of SRC ID (e.g. SRC device's RNTI), DST ID (e.g. DST device's RNTI) and connection ID (e.g. SL connection ID). For example, Xᵢ can be determined as defined in Equation 2.

When scrambling with SRC_RNTI, DST_RNTI and SL_Connection_ID
Xᵢ=(SRC_RNTIᵢ+DST_RNTIᵢ+SL_Connection_IDᵢ) mod 2

When scrambling with SRC_RNTI and DST_RNTI
Xᵢ=(SRC_RNTIᵢ+DST_RNTIᵢ) mod 2

When scrambling with DST_RNTI

Xᵢ=(SRC_RNTIᵢ+DST_RNTIᵢ) mod 2 (2)

In some embodiments, the length of the CRC may be extended beyond the length of the SRC_RNTI, DST_RNTI and SL_Connection_ID (e.g. to 24 bits) in order to reduce collisions. If the length of the CRC is greater than the length of the SRC_RNTI, DST_RNTI and SL_Connection_ID, Xᵢ can be calculated as defined in Equation 3.

Xᵢ=(SRC_RNTIᵢ<<SRC_K+DST_RNTIᵢ«DST_K+SL_Connection_IDᵢ<<SLID_K) mod 2 (3)
where “<<” represents shift left operation and SRC_K, DST_K and SLID_K are pre-configured integers that are selected to increase the length of Xᵢ.

In some embodiments, the second method of scrambling would be to scramble or encrypt the payload and CRC based on Xᵢ. According to embodiments, Xᵢ can be calculated based on Equations 2 and 3 illustrated above or equations similar thereto. In the second scrambling method, Xᵢ would be used as an encryption key. While using Xᵢ as an encryption key may not reduce collisions, using Xᵢ as an encryption key may add a level of privacy. It will be readily understood by a person skilled in the art that how the payload and CRC can be encrypted can be based on a key Xᵢ.

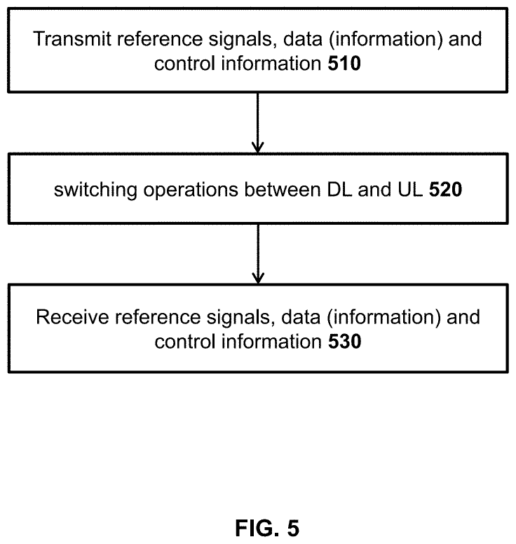

FIG. 5 is a method for supporting device to device (D2D) communication between a source (SRC) device and a destination (DST) device, in accordance with embodiments. The method includes transmitting 510, by the SRC device, one or more of reference signals, data information and control information (CI) in sub-frames (SFs) between two consecutive special SFs in a time division duplex (TDD) pattern. The method further includes switching 520, by the SRC device, operations between downlink (DL) and uplink (UL) in the one of the two consecutive special SFs or one of the other two consecutive special SFs. In the method, each frame of the TDD pattern includes at least two special SFs. The method further includes receiving 530, by the SRC device, one or more of other reference signals, other data information and other CI in other SFs between other two consecutive special SFs in the TDD pattern.

In some embodiments, each of the CI and the other CI includes a SRC identifier (ID) and a DST ID and is transmitted via a control channel (CCH). In some embodiments, the SRC device scrambles the CI with the DST ID, and the DST device scrambles the other CI with the SRC ID.

In some embodiments, the method further includes transmitting, by the SRC device, the DST device or both, synchronization information in one or more of the two consecutive special SFs and the other two consecutive special SFs. In some embodiments, the synchronization information includes one or more of synchronization signals and an information block. The information block includes information indicative of system frame timing.

In some embodiments, the method further includes determining, by the SRC device, a DST identifier (ID) for an initial communication with the DST device based on one or more of synchronization signals (SSs), an application ID, a pre-configured group ID and an information block. The information block includes information indicative of system frame timing. In some embodiments, the method further includes transmitting, by the SRC device, a connection request to the DST device, the connection request including the determined DST ID and a SRC ID. If the SRC ID is not known to the SRC device, the method further includes randomly selecting, by the SRC device, a temporary SRC ID.

In some embodiments, in response to the connection request, the method further includes receiving, by the SRC device from the DST device, a connection response. The connection response includes the SRC ID and the DST ID. In some embodiments, the method further includes transitioning, by the SRC device, into a D2D connected mode based on the connection response received from the DST device. The D2D connected mode enables transmission of the data information. In some embodiments, the DST device randomizes one or more of time and frequency of the connection response message and, wherein the SRC device randomizes one or more of time and frequency of the connection request message.

In some embodiments, if the SRC device does not receive a connection response from the DST device within a time period specified by a connection request timeout, the SRC device is prohibited from transmitting a subsequent connection request to the DST device for a predetermined amount of time. In some embodiments, if the SRC device receives a connection response including information indicative of rejection to the connection request, the SRC device refrains from transmitting a subsequent connection request to the DST device for a requested back-off time included in the connection response or a predetermined amount of time. In some embodiments, the predetermined amount of time increases exponentially each time that the connection request is rejected.

In some embodiments, the method further includes configuring, by the SRC device, the reference signals based on the DST ID, and configuring, by the DST device, the other reference signals based on the SRC ID. In some embodiments, the reference signals include one or more of a demodulation reference signal (DMRS) and cell-specific reference signal (CRS).

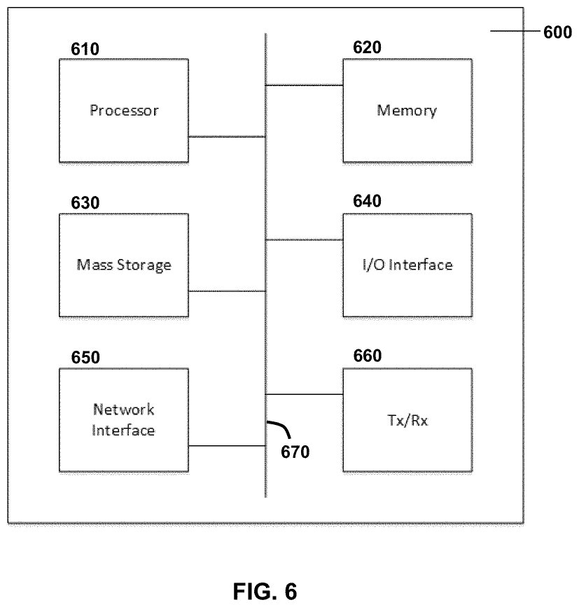

FIG. 6 is a schematic diagram of an electronic device 600 that may perform any or all of the steps of the above methods and features described herein, according to different embodiments of the present invention. For example, computer devices, wireless gateways, mobility routers, access point devices and core network devices, either virtualized or non-virtualized, can be configured as the electronic device. End-user computers, smartphones, IoT devices, etc. can be also configured as electronic devices.

As shown, the device includes a processor 610, memory 620, non-transitory mass storage 630, I/O interface 640, network interface 650, and a transceiver 660, all of which are communicatively coupled via bi-directional bus 670. According to certain embodiments, any or all of the depicted elements may be utilized, or only a subset of the elements. Further, the device 600 may contain multiple instances of certain elements, such as multiple processors, memories, or transceivers. Also, elements of the hardware device may be directly coupled to other elements without the bi-directional bus.

The memory 620 may include any type of non-transitory memory such as static random access memory (SRAM), dynamic random access memory (DRAM), synchronous DRAM (SDRAM), read-only memory (ROM), any combination of such, or the like. The mass storage element 630 may include any type of non-transitory storage device, such as a solid state drive, hard disk drive, a magnetic disk drive, an optical disk drive, USB drive, or any computer program product configured to store data and machine executable program code. According to certain embodiments, the memory 620 or mass storage 630 may have recorded thereon statements and instructions executable by the processor 610 for performing any of the aforementioned method steps described above.

As described above and elsewhere herein, some embodiments of the present invention provide a method and apparatus for supporting device to device (D2D) communication between a source (SRC) device and a destination (DST) device. In accordance with embodiments of the present invention, there is provided a method for supporting D2D communication between a SRC device and a DST device. The method includes determining, by the SRC device, a DST radio network temporary identifier (RNTI) for an initial communication with the DST device based on one or more of a sidelink synchronization signal (SLSS), a master information block (MIB), an application identifier and a pre-configured group RNTI. The method further includes transmitting, by the SRC device, a sidelink (SL) connection request to the DST device, the SL connection request including the determined RNTI. The method further includes transitioning, by the SRC device, into a sidelink (SL) connected mode based on a SL connection response received from the DST device in response to the SL connection request.

In some embodiments, when the SRC device and the DST device are in the SL connected mode, the DST device and the SRC device increase one or more time intervals for receiving data. In some embodiments, when the SRC device and the DST device are in the SL connected mode, the DST device and the SRC device enter into a time division duplex (TDD) pattern. In some embodiments, if the SRC device does not receive the SL connection response from the DST device within a time period specified by a connection request timeout, the SRC device backs off for a predetermined amount of time. In some embodiments, the predetermined amount of time increases exponentially after each failed attempt.

In some embodiments, the method further includes executing a SL-connection procedure and attempting authentication with the DST device, wherein the DST device has a stronger signal than other DST devices, each of the other DST devices having a RNTI different from the DST RNTI.

In some embodiments, the SRC device and the DST device are transitioned into a SL idle mode upon transmitting SL release requests. In some embodiments, the SRC device is configured to use a fixed timing advance.

In some embodiments, the DST device transmits sidelink control information (SCI) to the SRC device, and wherein the DST device scrambles sidelink control information cell-specific reference signal (SCI CRS) with a SRC RNTI. In some embodiments, the DST device acquires the SRC RNTI from one or more SCI messages received from the SRC device. In some embodiments, the DST device acquires the SRC RNTI only from the SCI connection request.

In some embodiments, the method further includes transmitting, by the SRC device, the SLSS and the MIB using a special subframe (SF) during the SL connected mode, the special SF configured to perform switching operations between downlink (DL) and uplink (UL). In some embodiments, the method further includes receiving, by the SRC device from the DST device, the SLSS and the MIB using a special subframe (SF) during the SL connected mode, the special SF configured to perform switching operations between downlink (DL) and uplink (UL).

In some embodiments, the DST device randomizes one or more of time and frequency of the SL connection response message. In some embodiments, the SRC device or the DST device is configured to transmit the SLSS using the special subframe (SF).

In some embodiments, the method further includes configuring a demodulation reference signal (DMRS) and cell-specific reference signal (CRS) based on the determined RNTI, the configuring performed for a control channel.

In some embodiments, the method further includes de-prioritizing the DST device when the DST device and one or more other DST devices share the DST RNTI. The method further includes informing higher layers that the DST device and the one or more DST devices share the DST RNTI and requesting reassignment of the DST RNTI.

In accordance with some embodiments of the present invention, there is provided a source (SRC) device for supporting device to device communication between a source device and a destination (DST) device. The SRC device includes a processor and machine readable memory storing machine executable instructions. The machine executable instructions, when executed by the processor configure the SRC device to determine a DST radio network temporary identifier (RNTI) for an initial communication with the DST device based on one or more of a sidelink synchronization signal (SLSS), a master information block (MIB), an application identifier and a pre-configured group RNTI. The machine executable instructions, when executed by the processor further configure the SRC device to transmit a sidelink (SL) connection request to the DST device, the SL connection request including the determined RNTI. The machine executable instructions, when executed by the processor configure the SRC device to transition into a sidelink (SL) connected mode based on a SL connection response received from the DST device in response to the SL connection request.

In some embodiments, when the SRC device and the DST device are in the SL connected mode, the SRC device increases one or more time intervals for receiving data. In some embodiments, when the SRC device and the DST device are in the SL connected mode, the SRC device enters into a time division duplex (TDD) pattern. In some embodiments, if the SRC device does not receive the SL connection response from the DST device within a time period specified by a connection request timeout, the SRC device backs off for a predetermined amount of time. In some embodiments, the predetermined amount of time increases exponentially after each failed attempt.

In some embodiments, the machine executable instructions, when executed by the processor further configure the SRC device to execute a SL-connection procedure and attempt authentication with the DST device, wherein the DST device has a stronger signal than other DST devices, each of the other DST devices having a RNTI different from the DST RNTI.

In some embodiments, the SRC device is transitioned into a SL idle mode upon transmitting SL release requests. In some embodiments, the SRC device is configured to use a fixed timing advance.

In some embodiments, SRC device receives sidelink control information (SCI) from the DST device, and the sidelink control information cell-specific reference signal (SCI CRS) is scrambled with a SRC RNTI. In some embodiments, the DST device acquires the SRC RNTI from one or more SCI messages received from the SRC device. In some embodiments, the DST device acquires the SRC RNTI only from the SCI connection request.

In some embodiments, the machine executable instructions, when executed by the processor further configure the SRC device to transmit the SLSS and the MIB using a special subframe (SF) during the SL connected mode, the special SF configured to perform switching operations between downlink (DL) and uplink (UL). In some embodiments, the machine executable instructions, when executed by the processor further configure the SRC device to receive, from the DST device, the SLSS and the MIB using a special subframe (SF) during the SL connected mode, the special SF configured to perform switching operations between downlink (DL) and uplink (UL).

In some embodiments, the DST device randomizes one or more of time and frequency of the SL connection response message. In some embodiments, the SRC device or the DST device is configured to transmit the SLSS using the special subframe (SF).

In some embodiments, the machine executable instructions, when executed by the processor further configure the SRC device to configure a demodulation reference signal (DMRS) and cell-specific reference signal (CRS) based on the determined RNTI, the configuring performed for a control channel.

In some embodiments, the machine executable instructions, when executed by the processor further configure the SRC device to de-prioritize the DST device when the DST device and one or more other DST devices share the DST RNTI. The machine executable instructions, when executed by the processor further configure the SRC device to inform higher layers that the DST device and the one or more DST devices share the DST RNTI and request reassignment of the DST RNTI.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for supporting device to device (D2D) communication between a source (SRC) device and a destination (DST) device, the method comprising:
transmitting, by the SRC device, one or more of reference signals, data information and control information (CI) in sub-frames (SFs) between two consecutive special SFs in a time division duplex (TDD) pattern;
receiving, by the SRC device, one or more of other reference signals, other data information and other CI in other SFs between other two consecutive special SFs in the TDD pattern; and
switching, by the SRC device, operations between downlink (DL) and uplink (UL) in the one of the two consecutive special SFs or one of the other two consecutive special SFs;
wherein each frame of the TDD pattern includes at least two special SFs.

2. The method of claim 1, wherein each of the CI and the other CI includes a SRC identifier (ID) and a DST ID and is transmitted via a control channel (CCH).

3. The method of claim 2, wherein the SRC device scrambles the CI with the DST ID, and wherein the DST device scrambles the other CI with the SRC ID.

4. The method of claim 1, further comprising:
transmitting, by the SRC device, the DST device or both, synchronization information in one or more of the two consecutive special SFs and the other two consecutive special SFs.

5. The method of claim 4, wherein the synchronization information includes one or more of synchronization signals and an information block, the information block including information indicative of system frame timing.

6. The method of claim 1, further comprising:
determining, by the SRC device, a DST identifier (ID) for an initial communication with the DST device based on one or more of synchronization signals (SSs), an application ID, a pre-configured group ID and an information block, the information block including information indicative of system frame timing.

7. The method of claim 6, further comprising:
transmitting, by the SRC device, a connection request CI to the DST device, the connection request CI including the determined DST ID and a SRC ID; and
if the SRC ID is not known to the SRC device, randomly selecting, by the SRC device, a temporary SRC ID.

8. The method of claim 7, further comprising:
in response to the connection request CI, receiving, by the SRC device from the DST device, a connection response CI, the connection response CI including the SRC ID and the DST ID.

9. The method of claim 8, further comprising:
transitioning, by the SRC device, into a D2D connected mode based on the connection response CI received from the DST device, the D2D connected mode enabling transmission of the data information.

10. The method of claim 8, wherein the DST device randomizes one or more of time and frequency of the connection response message and, wherein the SRC device randomizes one or more of time and frequency of the connection request message.

11. The method of claim 7, wherein if the SRC device does not receive a connection response from the DST device within a time period specified by a connection request timeout, the SRC device is prohibited from transmitting a subsequent connection request to the DST device for a predetermined amount of time.

12. The method of claim 7, wherein if the SRC device receives a connection response including information indicative of rejection to the connection request, the SRC device refrains from transmitting a subsequent connection request to the DST device for a requested back-off time included in the connection response or a predetermined amount of time, wherein the predetermined amount of time increases exponentially each time that the connection request is rejected.

13. The method of claim 1, further comprising:
configuring, by the SRC device, the reference signals based on the DST ID; and
configuring, by the DST device, the other reference signals based on the SRC ID;
wherein the reference signals include one or more of a demodulation reference signal (DMRS) and cell-specific reference signal (CRS).

14. A source (SRC) device comprising:
a processor; and
machine readable memory storing machine executable instructions which when executed by the processor configure the SRC device to:
transmit one or more of reference signals, data information and control information (CI) in sub-frames (SFs) between two consecutive special SFs in a time division duplex (TDD) pattern;
receive one or more of other reference signals, other data information and other CI in other SFs between other two consecutive special SFs in the TDD pattern; and
switch operations between downlink (DL) and uplink (UL) in the one of the two consecutive special SFs or one of the other two consecutive special SFs;
wherein each frame of the TDD pattern includes at least two special SFs.

15. The SRC device of claim 14, wherein each of the CI and the other CI includes a SRC identifier (ID) and a DST ID and is transmitted via a control channel (CCH).

16. The SRC device of claim 15, wherein the SRC device scrambles the CI with the DST ID, and wherein the DST device scrambles the other CI with the SRC ID.

17. The SRC device of claim 14, wherein the instructions when executed by the processor further configure the SRC device to:
transmit the DST device or both, synchronization information in one or more of the two consecutive special SFs and the other two consecutive special SFs.

18. The SRC device of claim 17, wherein the synchronization information includes one or more of synchronization signals and an information block, the information block including information indicative of system frame timing.

19. The SRC device of claim 14, further comprising:
determining, by the SRC device, a DST identifier (ID) for an initial communication with the DST device based on one or more of synchronization signals (SSs), an application ID, a pre-configured group ID and an information block, the information block including information indicative of system frame timing.

20. The SRC device of claim 19, wherein the instructions when executed by the processor further configure the SRC device to:
transmit, a connection request CI to the DST device, the connection request CI including the determined DST ID and a SRC ID; and
if the SRC ID is not known to the SRC device, randomly select a temporary SRC ID.

21. The SRC device of claim 20, wherein the instructions when executed by the processor further configure the SRC device to:
in response to the connection request, receive, from the DST device, a connection response, the connection response including the SRC ID and the DST ID.

22. The SRC device of claim 21, wherein the instructions when executed by the processor further configure the SRC device to:
transition into a D2D connected mode based on the connection response received from the DST device, the D2D connected mode enabling transmission of the data information.
